(19) United States
(12) Patent Application Publication
(10) Pub. No.: US 2010/0086095 A1
(43) Pub. Date: Apr. 8, 2010

(54) RADIOISOTOPE MANUFACTURING APPARATUS AND RADIOISOTOPE MANUFACTURING METHOD

(75) Inventors: Tsuyoshi OGASAWARA, Niihama-shi (JP); Satoru YAJIMA, Niihama-shi (JP); Masami SANO, Niihama-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: SUMITOMO HEAVY INDUSTRIES, LTD., Tokyo (JP)

(21) Appl. No.: 12/633,074

(22) Filed: Dec. 8, 2009

Related U.S. Application Data
(63) Continuation of application No. PCT/JP2008/057008, filed on Apr. 9, 2008.

(30) Foreign Application Priority Data
Jun. 8, 2007 (JP) 2007-153077

(51) Int. Cl. G21G 1/10; G21K 5/08

(52) U.S. Cl. 376/202

(57) ABSTRACT

Improvements in both the pressure resistance of a target and the cooling effect of a target liquid can be made compatible, and the boiling of the target liquid is sufficiently suppressed. A radioisotope manufacturing apparatus can include a radiation source which radiates radioactive rays, and a target having a holding unit which holds the target liquid. The holding unit can include a spherical bottom surface which is recessed in a direction away from the radiation source so as to have an apex. The target can be disposed so that the intersection position between a radiation axis of radioactive rays radiated from the radiation source and the bottom surface can be located below the apex.

### CROSS-REFERENCE TO RELATED APPLICATIONS

This application is a U.S. continuation application filed under 35 USC 111(a) claiming benefit under 35 USC 120 and 365(c) of PCT application JP08/057,008, filed Apr. 9, 2008, which claims priority to Application Ser. No. 2007-153077, filed in Japan on Jun. 8, 2007. The foregoing applications are hereby incorporated herein by reference.

### BACKGROUND OF THE INVENTION

1. Field of the Invention

The present invention relates to a radioisotope manufacturing apparatus and a radioisotope manufacturing method for manufacturing a radioisotope by using a nuclear reaction between target liquid and radioactive rays.

2. Description of Related Art

There is a positron emission tomography (PET) used as an inspection method in complete examinations of brains, hearts, cancers, and the like. In this PET examination, a drug used in examinations, which is marked by a radioisotope (positron-emitting radionuclide) and emits a positron, is introduced into a subject's body by injection, inhalation, etc. The drug used in examinations and introduced into the body is metabolized, or is accumulated in a specific part (for example, a tumor or an affected area). Since radioactive rays (annihilation gamma-rays) are emitted when a positron emitted from a radioisotope and its surrounding electrons are coupled together and are annihilated, a tomogram image in a specific section can be obtained by detecting the radioactive rays and processing them by a computer.

As radioisotopes used for the drug used in examinations in the PET examinations, there are ¹⁸F, ¹⁵O, ¹¹C, ¹³N, etc. Since these have a very short half-life period of 2 to 110 minutes, a source of radioactive rays, such as a cyclotron, is set at a location near a laboratory in a hospital, radioactive rays (for example, particle rays, such as proton rays or deuteron rays) from this radiation source are guided to a target, and a radioisotope is manufactured by a nuclear reaction with the target liquid (for example, target water (¹⁸O water)) held in the target. Then, a drug used in examinations (for example, ¹⁸F-FDG) is manufactured by incorporating the manufactured radioisotope into a predetermined compound (for example, Fluoro-Deoxy-Glucose (FDG)), or replacing a portion thereof, thereby performing synthesis.

As a target for manufacturing such a radioisotope, conventionally, a target which has a holding unit which holds a target liquid and which has the holding unit defined by one flat bottom surface and four flat side surfaces is known (for example, refer to Japanese Patent Unexamined Publication No. 9-54196).

Meanwhile, since the radioactive rays radiated from the radiation source have extremely high energy of about ten or more MeV, if the target liquid held in the holding unit of the target is irradiated with the radioactive rays, the target liquid may be heated and the target liquid may boil. At this time, a number of bubbles are generated in the target liquid, and the reaction between the target liquid and the radioactive rays is not sufficiently performed. Additionally, since there is hardly any attenuation of the energy of the radioactive rays when the radioactive rays pass through the bubbles, the radioactive rays reach the target due to the existence of the bubbles, and the material which constitutes the target (for example, Nb, Ag) is easily sputtered. As a result, the sputtered material may precipitate in a tube or a filter used for recovering the generated radioisotope, and thus, maintenance has to be performed. Therefore, there is a requirement for the target liquid to sufficiently cool so as to suppress boiling of the target liquid.

Here, as a measure for suppressing the boiling of the target liquid, it is considered that the heat exchange between the cooling water and the target liquid is promoted by making a thin walled portion in a side wall which constitutes the holding unit. Additionally, it is considered that inert gas, such as helium gas, is supplied into the holding unit which holds the target liquid so as to raise the pressure within the holding unit, and the boiling point of the target liquid is increased.

However, since the holding unit in the conventional target is defined by one flat bottom surface and four flat side surfaces, stress tends to be concentrated on a corner of the holding unit when the pressure with the holding unit is raised. Therefore, in the conventional target, there is a limit to forming the holding unit into a thin-walled shell shape and raising the pressure within the holding unit, and it is difficult to sufficiently suppress boiling of the target liquid.

### SUMMARY OF THE INVENTION

The object of the invention is to provide a radioisotope manufacturing apparatus and a radioisotope manufacturing method where improvements in both the pressure resistance of a target and the cooling effect of a target liquid can be made compatible, and can sufficiently suppress the boiling of the target liquid.

The radioisotope manufacturing apparatus according to the invention can be a radioisotope manufacturing apparatus for manufacturing a radioisotope by a nuclear reaction between target liquid and radioactive rays. The apparatus can include a radiation source which radiates radioactive rays, and a target having a holding unit which holds the target liquid. The holding unit can include a concave surface which is recessed in a direction toward a direction away from the radiation source so as to have an apex. A target can be disposed so that the intersection position between the radiation axis of the radioactive rays radiated from the radiation source and the concave surface can be located below the apex.

In the radioisotope manufacturing apparatus according to the invention, the holding unit can include a concave surface which is recessed in a direction away from the radiation source so as to have an apex. Therefore, there is hardly any stress concentration in the holding unit, and the resistance to the pressure of the holding unit is improved. As a result, since the pressure within the holding unit can be sufficiently raised even if a portion of holding unit is formed into a thin-walled shell, improvements in both the pressure resistance of the target and the cooling effect of the target liquid can be made compatible, and it is possible to sufficiently suppress the boiling of the target liquid. Thereby, since the reactivity between radioactive rays and the target liquid can be improved, and the target liquid can be irradiated with higher energy radioactive rays, the yield of the radioisotope increases.

Additionally, in the radioisotope manufacturing apparatus according to the invention, the holding unit can include a concave surface which is recessed in a direction away from the radiation source so as to have an apex. Therefore, when the volume of the holding unit is made the same as the volume of a holding unit in a conventional target, and the amount of the target liquid used is made the same as the conventional amount, as compared with the conventional technique, the depth (rectilinear distance in the direction of the radiation axis of radioactive rays to the apex) of the holding unit is large. As a result, even when the target liquid boils and bubbles are generated, the energy of radioactive rays is easily attenuated by the target liquid as compared with the conventional technique. Thus, it is possible to restrain the target from being sputtered.

Additionally, in the radioisotope manufacturing apparatus according to the invention, the target can be disposed so that the intersection position between the radiation axis of the radioactive rays radiated from the radiation source and the concave surface can be located below the apex. Since the temperature of the portion, which is located on the lower side, of the target liquid held in the holding unit tends to be lower than the temperature of the portion which is located on the upper side, this causes radioactive rays to be radiated onto the portion of the target liquid with the lower temperature. As a result, it is considered that a rise in the local temperature of the target liquid is suppressed, and it is possible to more sufficiently suppress boiling of the target liquid.

Additionally, in the radioisotope manufacturing apparatus according to the invention, the target can be disposed so that the intersection position between the radiation axis of the radioactive rays radiated from the radiation source and the concave surface is located below the apex. Since the target liquid heated by the radioactive rays tends to move up, this easily causes convective flows in the target liquid. As a result, a rise in the local temperature of the target liquid is suppressed, and it is possible to more sufficiently suppress boiling of the target liquid.

On the other hand, the radioisotope manufacturing method according to the invention can be a radioisotope manufacturing method including the steps of preparing the radioisotope manufacturing apparatus according to the radioisotope manufacturing apparatuses, circulating the coolant for cooling the target, holding the target liquid within the holding unit so as to leave a predetermined air gap within the holding unit above the apex, and radiating radioactive rays toward the target from the radiation source so that the intersection position between the radiation axis and the concave surface is located below the apex, and the irradiation area of the radioactive rays radiated from the radiation source falls within the target liquid.

In the radioisotope manufacturing method according to the invention, the same effects as the aforementioned radioisotope manufacturing apparatus are exhibited. Additionally, in the radioisotope manufacturing method according to the invention, the target liquid can be held within the holding unit so as to leave a predetermined air gap within the holding unit above the apex. Therefore, even when the target liquid has boiled, condensation of the target liquid which has evaporated is performed in the predetermined air gap. As a result, condensation heat transfer can further improve the cooling effect of the target liquid.

According to the invention, it is possible to provide a radioisotope manufacturing apparatus and a radioisotope manufacturing method where improvements in both the pressure resistance of a target and the cooling effect of a target liquid can be made compatible, and can sufficiently suppress the boiling of the target liquid.

### BRIEF DESCRIPTION OF THE DRAWINGS

FIG. 1 is a sectional view showing a radioisotope manufacturing apparatus according to one example.

FIG. 2 is a sectional view showing a target portion of FIG. 1 in an enlarged manner.

FIG. 3 is a front perspective view showing a state where a portion has been cut out of a target of the radioisotope manufacturing apparatus according to one example.

FIG. 4 is a rear perspective view showing a state where a portion has been cut out of the target of the radioisotope manufacturing apparatus according to one example.

FIG. 5 is a rear view showing the target of the radioisotope manufacturing apparatus according to one example.

FIG. 6 is a sectional view showing the target portion of the radioisotope manufacturing apparatus according to one example in an enlarged manner, with a cut at a line VI-VI of FIG. 5.

FIG. 7 is a sectional view showing a radioisotope manufacturing apparatus according to another example.

FIG. 8 is a sectional view showing a target portion of FIG. 7 in an enlarged manner.

FIG. 9 is a front perspective view showing a state where a portion has been cut out of a target of the radioisotope manufacturing apparatus according to another example.

FIG. 10 is a rear perspective view showing a state where a portion has been cut out of the target of the radioisotope manufacturing apparatus according to another example.

FIG. 11 is a rear view showing the target of the radioisotope manufacturing apparatus according to another example.

FIG. 12 is a front perspective view showing a state where a portion has been cut out of a bowl-like member which the radioisotope manufacturing apparatus according to another example.

FIG. 13 is a front view showing the bowl-like member of the radioisotope manufacturing apparatus according to another example.

### DETAILED DESCRIPTION OF THE INVENTION

A preferred embodiment of a radioisotope manufacturing apparatus according to the invention will be described with reference to the drawings. Additionally, although the teens “upper” and “lower” are used in the description, these correspond to the “upward direction” and “downward direction” in the drawings.

(1) One Example of the Invention

(1.1) Configuration of Radioisotope Manufacturing Apparatus

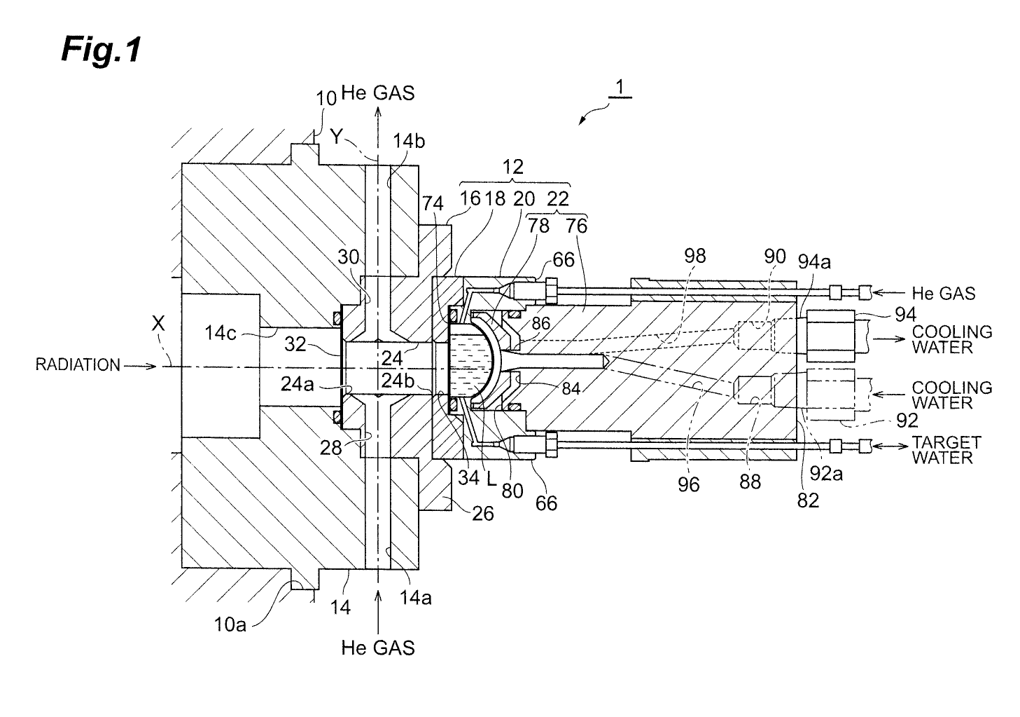

As shown in FIG. 1, a radioisotope manufacturing apparatus 1 according to one example includes a cyclotron (radiation source) 10 and a target device 12. The cyclotron 10 radiate radioactive rays (for example, particle rays, such as proton rays or deuteron rays) along a radiation axis X.

The target device 12 is mounted on an outlet port 10a of the cyclotron 10 through which radioactive rays are output via a manifold 14. The target device 12 includes a first body portion 16, a second body portion 18, a target 20, and a third body portion 22.

The first body portion 16 is a cylindrical member which connects an opening 24a and an opening 24b, and has a passage hole 24 extending in the radiation axis X. The first body portion 16 can be formed from, for example, an aluminum alloy. The first body portion 16 has an outward flange portion 26 at its base end.

Side walls of the first body portion 16 are provided with a pair of holes, inlet hole 28 and outlet hole 30, which extend along an axis Y orthogonal to the radiation axis X and communicates with the passage hole 24. The inlet hole 28 and the outlet hole 30 branch out in a Y-shape so that the distal ends (ends which face the passage hole 24) thereof face the opening 24a and opening 24b of the passage hole 24. Helium gas used as a refrigerant is supplied into the passage hole 24 from the inlet hole 28. The helium gas supplied into the passage hole 24 from the inlet hole 28 is discharged from the outlet hole 30.

The first body portion 16 is mounted on the manifold 14 so that the inlet hole 28 communicates with an inlet hole 14a of the manifold 14, and the outlet hole 30 communicates with an outlet hole 14b of the manifold 14. At this time, a foil 32 pinched by the first body portion 16 and the manifold 14 is disposed between the first body portion 16 and the manifold 14. Therefore, the passage hole 24 of the first body portion 16 and a passage hole 14c of the manifold 14 are separated by the foil 32.

While the foil 32 permits the passage of radioactive rays, it shields the passage of fluids, such as air or helium gas. The foil 32 is a circular thin foil which is formed from, for example, metal such as Ti or alloy, and the thickness thereof is set to about 10 μm to 50 μm.

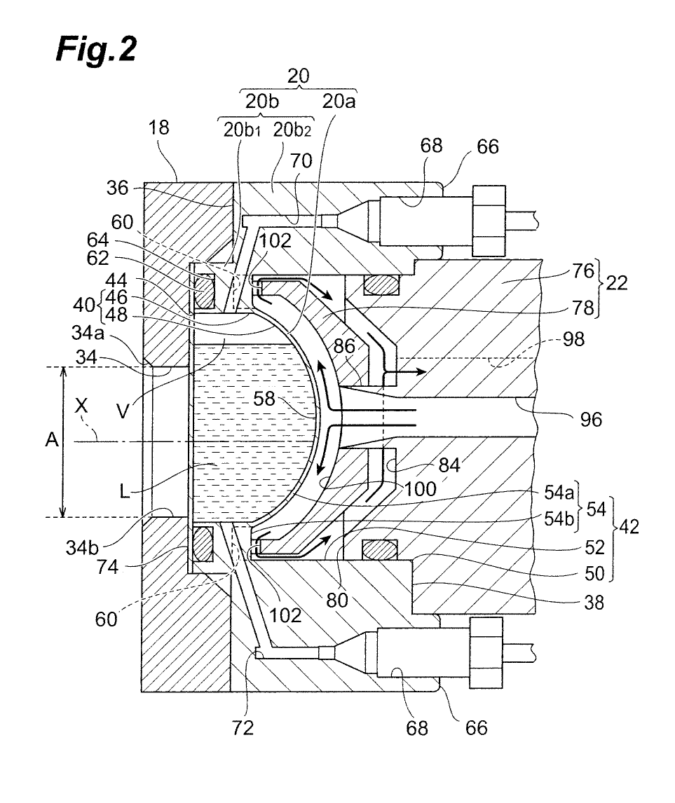

As shown in detail in FIG. 2, the second body portion 18 is a cylindrical member which connects an opening 34a and an opening 34b, and has a passage hole 34 extending in the radiation axis X. The second body portion 18 can be formed from, for example, an aluminum alloy. The second body portion 18 is mounted on the first body portion 16 so that the passage hole 34 communicates with the passage hole 24 of the first body portion 16.

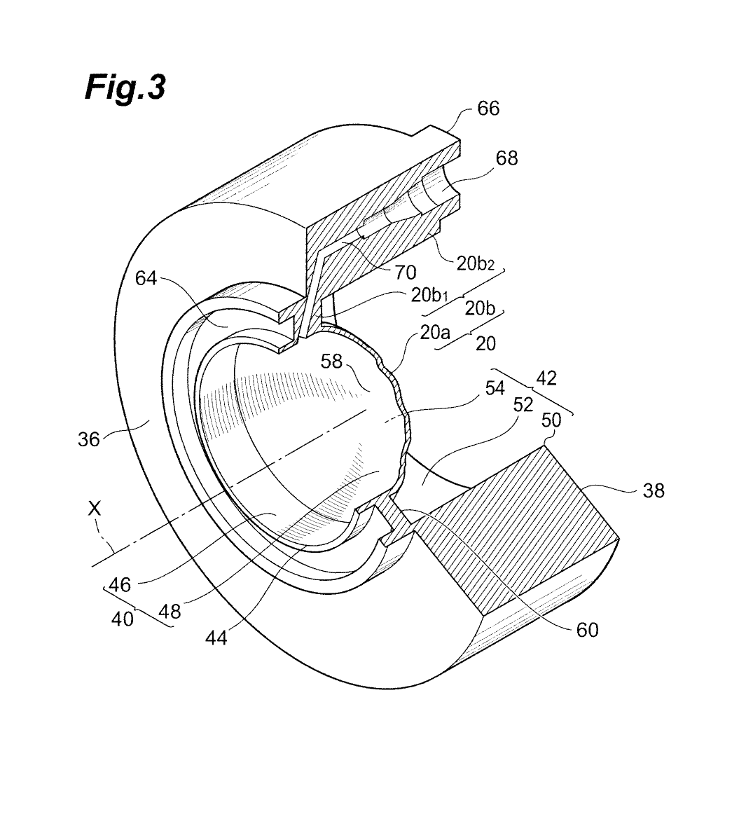

As shown in detail in FIGS. 2 to 4, the target 20 is a member which has a distal end face 36 and a base end face 38 which are substantially orthogonal to the radiation axis X and which assumes a cylindrical shape. The target 20 can be formed from, for example, Nb. The target 20 has a spherical thin-walled shell-like portion 20a, and an annular supporting portion 20b which supports the thin-walled shell-like portion 20a so as to surround the periphery of the thin-walled shell-like portion 20a. Therefore, in the target 20, a holding unit 40 which holds a target liquid (target water (¹⁸O) in this embodiment) L is formed at the distal end face 36 by a space surrounded by the thin-walled shell-like portion 20a and the annular supporting portion 20b, and a fitting recess 42 into which the third body portion 22 is fitted is formed at the base end face 38. In addition, the target 20 is provided with an opening 44 for introducing the radioactive rays radiated from the cyclotron 10, and an opening 50 for introducing the third body portion 22.

The holding unit 40 has a bottom surface (concave surface) 48 which assumes a spherical shape which is recessed in a direction away from the cyclotron 10 with respect to the opening 44, and an inner wall surface 46 which is connected with the bottom surface 48 and whose cross-section assumes a circular shape.

The fitting recess 42 is recessed in a direction toward the holding unit 40 from the base end face 38 side (the side opposite to the holding unit 40). The fitting recess 42 has a bottom surface 54, and an inner wall surface 52 which is connected with the bottom surface 54, and whose cross-section assumes a circular shape. The bottom surface 54 includes a convex surface 54a which assumes a spherical shape and protrudes toward a direction (the same direction as the direction in which the bottom surface 48 is recessed) approaching the opening 50, and a flat surface 54b which spreads around the convex surface 54a.

The convex surface 54a of the fitting 42 is thin-walled at the bottom surface 48 of the holding unit 40. That is, the thin-walled shell-like portion 20a has an apex 58, and forms the convex surface 54a of the fitting recess 42 while forming the bottom surface 48 of the holding unit 40.

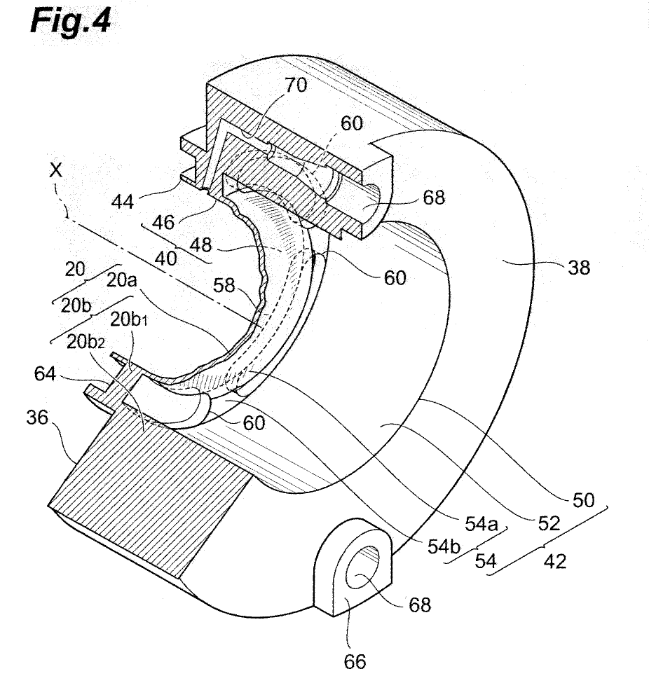

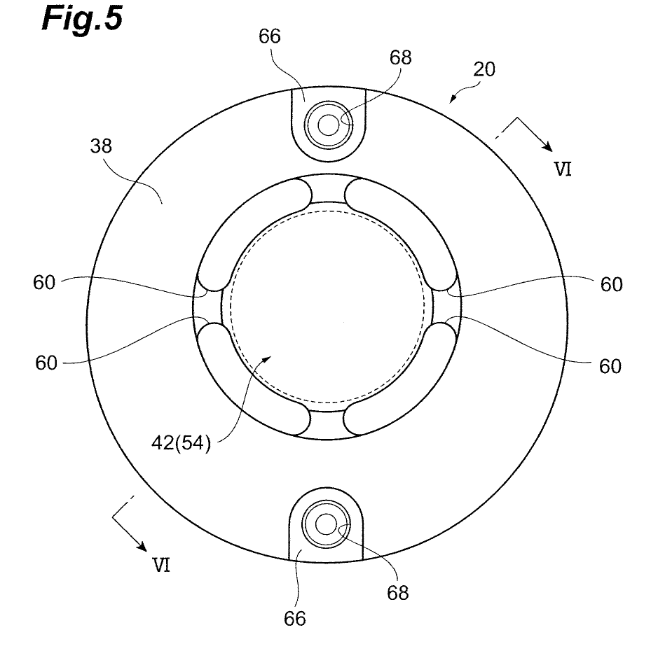

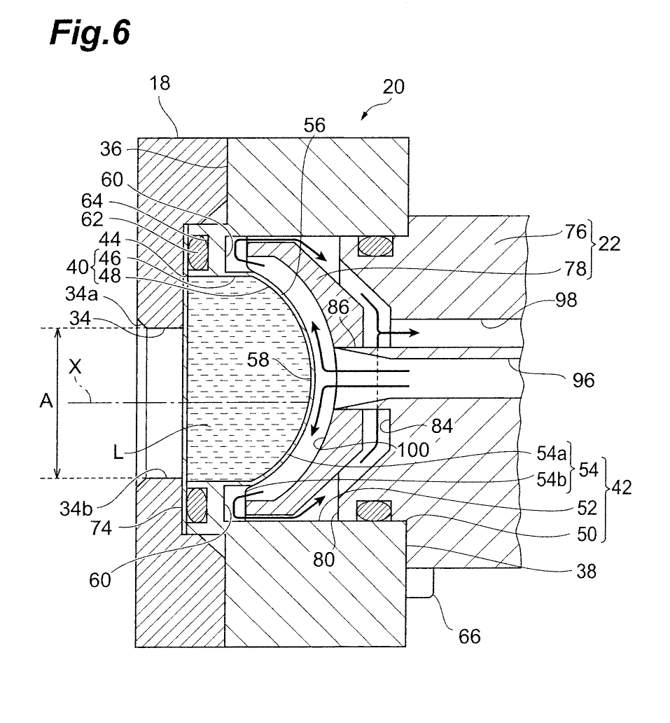

The annular supporting portion 20b includes a first portion 20b₁ which is directly connected with the thin-walled shell-like portion 20a, and a second portion 20b₂ which further surrounds the outside of the first portion 20b₁. A portion of the first portion 20b₁ forms the inner wall surface 46 of the holding unit 40, and forms the flat surface 54b of the fitting recess 42 (refer to FIGS. 2 to 4). The flat surface 54b which forms a portion of the first portion 20b₁ is provided with a plurality of (four in the first embodiment) recesses 60 which are recessed in a direction which faces the radioactive rays radiating from the cyclotron 10 (refer to FIGS. 4 and 5). The recesses 60 are formed so that each surrounds a portion of the inner wall surface 46 of the holding unit 40 (refer to FIGS. 2 and 6), and assume a substantially circular-arc shape as seen from the radiation axis X (refer to FIGS. 4 and 5). The recesses 60 are formed so as to avoid a gas introduction hole 70 and a carrying hole 72 which will be described later.

The distal end face 36 of the target 20 is provided with an annular recess 64 which houses an O ring 62 used as a sealing member.

A pair of protruding portions 66 is provided at base end face 38 of the target 20 so as to protrude therefrom across the fitting recess 42. A ferrule receiving hole 68 which extends in the direction of the radiation axis X is bored in each protruding portion 66. The gas introduction hole 70 for introducing helium gas into the holding unit 40 extends at the target 20 so as to pass through the target from the ferrule receiving hole 68, which is located on the upper side, to the holding unit 40. In the target 20, the carrying hole 72 for carrying a target liquid L into/from the holding unit 40 extends so as to pass through the target from the ferrule receiving hole 68, which is located on the lower side, to the holding unit 40.

The target 20 is mounted on the second body portion 18 so that the holding unit 40 faces the passage hole 34 of the second body portion 18. At this time, the target 20 is disposed so that the radiation axis X of the radioactive rays which are radiated from the cyclotron 10 is located directly below the apex 58 at the bottom surface 48 of the holding unit 40. Accordingly, the intersection position between the radiation axis X and the bottom surface 48 of the holding unit 40 is located directly below the apex 58.

Additionally, at this time, a foil 74 pinched by the target 20 and the second body portion 18 is disposed between the target 20 and the second body portion 18. Therefore, the holding unit 40 of the target 20 and the passage hole 34 of the second body portion 18 are separated by the foil 74.

While the foil 74 permits the passage of radioactive rays, it shields the passage of fluid, such as air or helium gas. The foil 74 is a circular thin foil which is formed from, for example, metal such as Ti or alloy, and the thickness thereof is set to about 10 μm to 50 μm.

Referring back to FIG. 1, the third body portion 22 has a main body 76 which forms a cylindrical shape, and a bowl-like member 78 provided at the distal end of the main body 76. The third body portion 22 can be formed from, for example, an aluminum alloy.

The main body 76 has a distal end face 80 and a base end face 82 which are substantially orthogonal to the radiation axis X. The distal end face 80 of the main body 76 is provided with a recess 84 which is recessed in a direction toward the base end face 82 and a protruding portion 86 is provided at the central portion of the recess 84 so as to protrude therefrom.

A pair of nozzle holes 88 and 90 which extend along the radiation axis X is provided on the side of the base end face 82 in the main body 76. A nozzle 92a of a supply pipe 92 for supplying cooling water is fitted into a nozzle hole 88 which is located on the lower side. A nozzle 94a of a recovery pipe 94 for recovering cooling water is fitted into a nozzle hole 90 which is located on the upper side.

A guide hole 96 for guiding cooling water extends at the main body 76 so as to pass through the main body from the nozzle hole 88 to the protruding portion 86 of the distal end face 80. In the first embodiment, the distal end (portion on the side of the distal end face 80) of the guide hole 96 is formed in a funnel shape whose diameter increases toward the distal side (refer to FIGS. 1 and 2). A guide hole 98 for guiding cooling water extends at the main body 76 so as to pass through the main body from the nozzle hole 90 to the recess 84 of the distal end face 80.

The bowl-like member 78 has a bottom surface 100 which assumes a shape (a spherical shape) corresponding to the convex surface 54a of the fitting recess 42. A distal end of the bowl-like member 78 is provided with a pair of cutout portions 102. The third body portion 22 is fitted into the fitting recess 42 of the target 20 so that the tip of the bowl-like member 78 abuts with the flat surface 54b of the fitting recess 42 of the target 20.

(1.2) Manufacturing Method of Radioisotope

Subsequently, a radioisotope manufacturing method using the radioisotope manufacturing apparatus 1 having the above configuration will be described.

First, supply of cooling water is started from the supply pipe 92, and the cooling water is circulated in the following order; the guide hole 96 of the third body portion 22, the space between the flat surface 54b of the fitting recess 42 and the bottom surface 100 of the bowl-like member 78, the recesses 60 of the fitting recess 42 and the cutout portion 102 of the bowl-like member 78, the recess 84 of the third body portion 22, the guide hole 98 of the third body portion 22, and the recovery pipe 94 (refer to the arrow of FIG. 2). At this time, since the flat surface 54b of the fitting recess 42 is provided with the plurality of recesses 60, as shown in FIG. 6, the cooling water circulates through the inside of each recess 60 so as to turn around the tip of the bowl-like member 78.

Next, supply of helium gas used as a refrigerant is started from the inlet hole 14a of the manifold 14, and the helium gas is made to flow in the order of the inlet hole 28 of the first body portion 16, the passage hole 24 (particularly toward the foils 32 and 74), the outlet hole 30, and the outlet hole 14b of the manifold 14.

Next, the target liquid L is supplied to the holding unit 40 through the carrying hole 72 so as to leave a predetermined space V (refer to FIG. 2) within the holding unit 40. At this time, in order to prevent radioactive rays from being directly radiating to the target 20, the water surface of the target liquid L is set to be higher than the upper end of the passage hole 34 of the second body portion 18 (refer to FIGS. 1 and 2). Since the radioactive rays pass through the passage hole 34 of the second body portion 18 and are guided to the target 20, the irradiation area A of the radioactive rays (refer to FIG. 2) will accordingly fall within the target liquid L.

Next, the helium gas is supplied into the holding unit 40 at high pressure via the gas introduction hole 70. By pressurizing the helium gas in this way, generation of bubbles due to boiling of the target liquid L is suppressed.

In this state, radioactive rays are radiated toward the target 20 from the cyclotron 10. The radioactive rays radiated from the cyclotron 10 pass through the passage hole 14c of the manifold 14, the foil 32, the passage hole 24 of the first body portion 16, the passage hole 34 of the second body portion 18, and the foil 74 in this order along the radiation axis X, and reach the inside of the holding unit 40 of the target 20. Then, a nuclear reaction expressed by ¹⁸O(p, n)¹⁸F is performed between the target liquid L held within the holding unit 40 of the target 20 and the radioactive rays. This generates the radioisotope expressed by ¹⁸F⁻ as a primary product. The target liquid L including the generated radioisotope is made to flow back through the carrying hole 72, and is recovered through a filter (not shown).

Then, ¹⁸F-FDG serving as a drug used in examinations in the PET examinations is synthesized using the recovered radioisotope.

(1.3) Operation and Effect

In the one example described above, the target 20 is constituted by the thin-walled shell-like portion 20a which has the apex 58, and the annular supporting portion 20b which supports the thin-walled shell-like portion 20a, where one side of the thin-walled shell-like portion 20a forms the bottom surface 48 which assumes a spherical shape and is recessed in a direction away from the cyclotron 10 with respect to the opening 44. Therefore, there is hardly any stress concentration in the holding unit 40, and the resistance to the pressure of the holding unit 40 improves. As a result, since the pressure within the holding unit 40 can be sufficiently raised, improvements in both the pressure resistance of the target 20 and the cooling effect of the target liquid L can be made compatible, and it is possible to sufficiently suppress the boiling of the target liquid L. Thereby, since the reactivity between radioactive rays and the target liquid L can be improved, and the target liquid L can be irradiated with higher energy radioactive rays, the yield of the radioisotope increases.

Additionally, in the one example described above, the target 20 is constituted by the thin-walled shell-like portion 20a which has the apex 58, and the annular supporting portion 20b which supports the thin-walled shell-like portion 20a, where one side of the thin-walled shell-like portion 20a forms the bottom surface 48 which assumes a spherical shape and is recessed in a direction away from the cyclotron 10 with respect to the opening 44. Therefore, when the volume (equivalent to the total of the volume of the target liquid L and the space V) of the holding unit 40 is made the same as the volume of a holding unit in a conventional target, and the amount of the target liquid L used is made the same as the conventional amount, as compared with the conventional technique, the depth (rectilinear distance from the opening 44 in the direction of the radiation axis X of radioactive rays to the apex 58) of the holding unit 40 is large. As a result, even when the target liquid L boils and bubbles are generated, the energy of radioactive rays is easily attenuated by the target liquid L as compared with the conventional technique. Thus, it is possible to restrain the target 20 from being sputtered.

Additionally, in the one example described above, the target 20 is constituted by the thin-walled shell-like portion 20a which has the apex 58, and the annular supporting portion 20b which supports the thin-walled shell-like portion 20a, where one side of the thin-walled shell-like portion 20a forms the bottom surface 48 which assumes a spherical shape and is recessed in a direction away from the cyclotron 10 with respect to the opening 44. Therefore, it is possible to further promote the heat exchange between the cooling water and the target liquid L.

Additionally, in the one example, the target 20 is disposed so that the intersection position between the radiation axis X of the radioactive rays which are radiated from the cyclotron 10 and the bottom surface 48 of the holding unit 40 is located directly below the apex 58. Since the temperature of the portion, which is located on the lower side, in the target liquid L held in the holding unit 40 tends to be lower than the temperature of the portion which is located on the upper side, this causes radioactive rays to be radiated onto the portion of the target liquid L with the lower temperature. As a result, it is considered that a rise in the local temperature of the target liquid L is suppressed, and it is possible to more sufficiently suppress boiling of the target liquid L.

Additionally, in the one example, the target 20 is disposed so that the intersection position between the radiation axis X of the radioactive rays which are radiated from the cyclotron 10 and the bottom surface 48 of the holding unit 40 is located directly below the apex 58. Since the target liquid L heated by the radioactive rays tends to move up, convective flows easily occur in the target liquid L. As a result, a rise in the local temperature rise of the target liquid L is suppressed, and it is possible to more sufficiently suppress boiling of the target liquid L.

Additionally, in the one example, when a radioisotope is manufactured, the target liquid L is supplied to the holding unit 40 so as to leave the predetermined space V within the holding unit 40. Therefore, even when the target liquid L has boiled, condensation of the target liquid L which has evaporated is performed in the space V. As a result, condensation heat transfer makes it possible to further improve the cooling effect of the target liquid L.

Additionally, in the one example, the flat surface 54b which forms a portion of the first portion 20b₁ of the annular supporting portion 20b is provided with four recesses 60 surrounding a portion of the inner wall surface 46 of the holding unit 40. Therefore, the walls of the portion of the annular supporting portion 20b between the recesses 60 and the holding unit 40 are made thinner by the recesses 60. Thus, as cooling water circulates through the insides of the recesses 60, the heat exchange between the cooling water and the target liquid L can be further promoted, and a greater cooling effect can be obtained.

(2) Another Example of the Invention

(2.1) Configuration of Radioisotope Manufacturing Apparatus

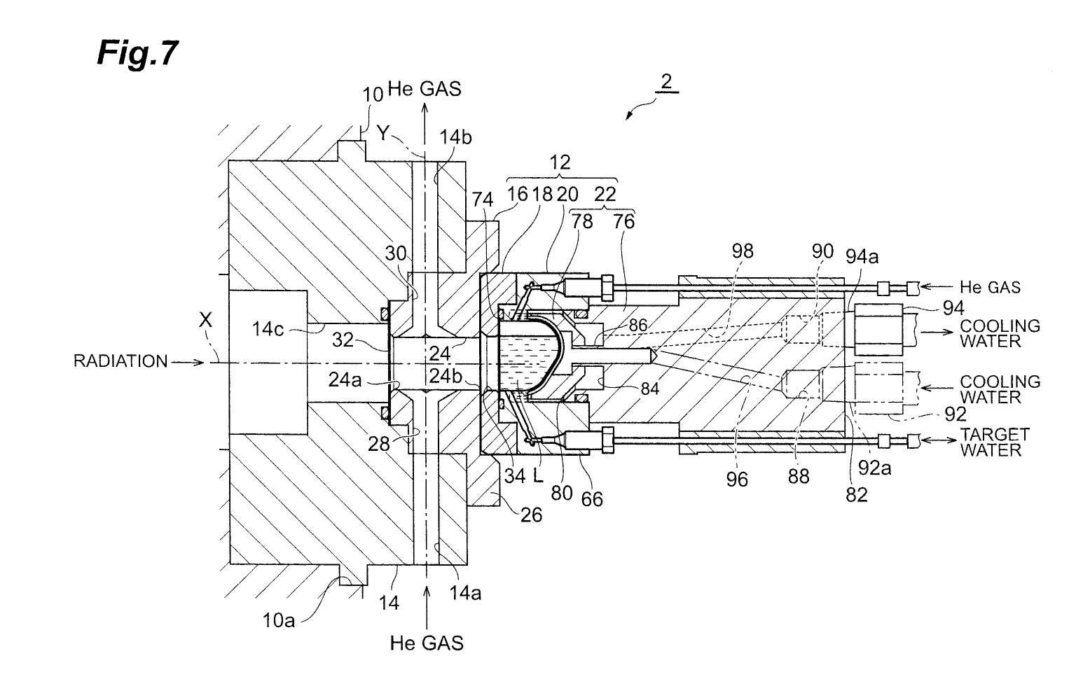

Subsequently, referring to FIGS. 7 to 13, the configuration of the radioisotope manufacturing apparatus 2 according to another example will be described focusing on differences from the radioisotope manufacturing apparatus 1 according to the one example.

The target 20, as shown in FIGS. 7 to 11, has a spherical thin-walled shell-like portion 20a, and an annular supporting portion 20b which supports the thin-walled shell-like portion 20a so as to surround the periphery of the thin-walled shell-like portion 20a. Therefore, in the target 20, a holding unit 40 which holds a target liquid L is formed at the distal end face 36 by a space surrounded by the thin-walled shell-like portion 20a and the annular supporting portion 20b, and a fitting recess 42 into which the third body portion 22 is fitted is formed at the base end face 38. In addition, in the another example, the protruding portions 66 are not provided at the base end face 38 of the target 20.

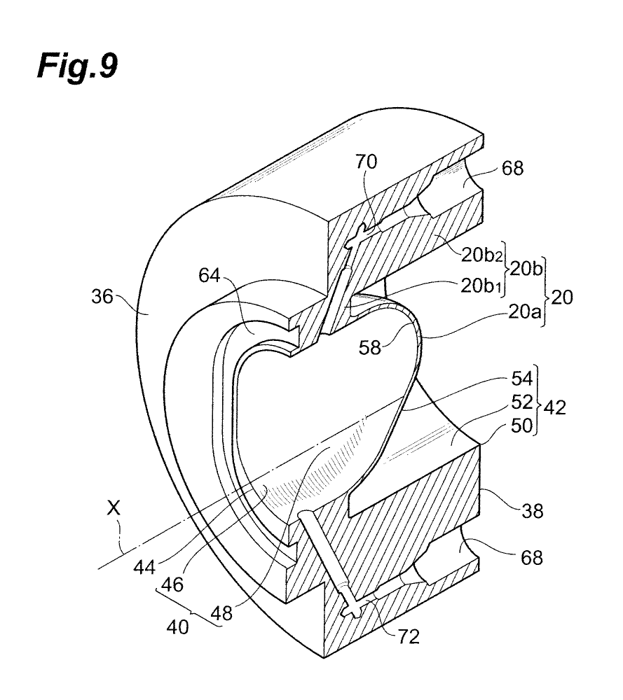

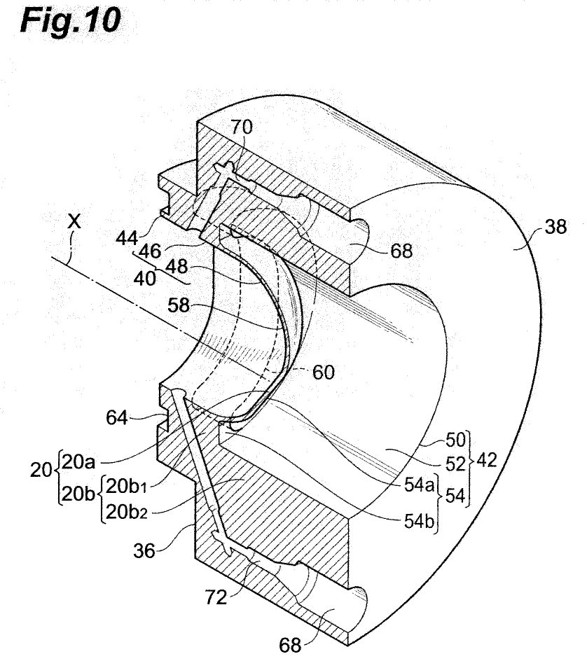

The holding unit 40 has the inner wall surface 46, and the bottom surface (concave surface) 48. The shape (the whole shape of the inner wall surface 46, and the bottom surface 48) of the holding unit 40 assumes an annular shape which is long in the vertical direction as seen from the radiation axis X, as shown in detail in FIGS. 9 and 10. Specifically, in the another example, the holding unit 40 assumes the shape of a racetrack as seen from the radiation axis X.

Here, the racetrack shape refers to a shape which has first and second circular-arc portions, and first and second straight portions, and in which the first and second circular-arc portions are arranged so that an opening of the first circular-arc portion and an opening of the second circular-arc portion face each other, one end of the first circular-arc portion and one end of the second circular-arc portion on the side of the one end are connected by the first straight portion, and the other end of the first circular-arc portion and the other end of the second circular-arc portion connected by the second straight portion. The curvatures of the respective circular-arc portions are equal to each other at the opening 44 and the inner wall surface 46 (refer to FIGS. 9 and 10). In addition, the opening 44 and the inner wall surface 46 may be elliptical or the like as seen from the radiation axis X.

The bottom surface 48 is continuously connected with the inner wall surface 46, and assumes a curved shape which is recessed in a direction away from the cyclotron 10 (the side where radioactive rays are radiated) with respect to the opening 44.

The walls of the bottom surface 48 of the holding unit 40 and the convex surface 54a of the fitting recess 42 are made to be thin. That is, the thin-walled shell-like portion 20a has the apex 58, and protrudes toward the base end face 38.

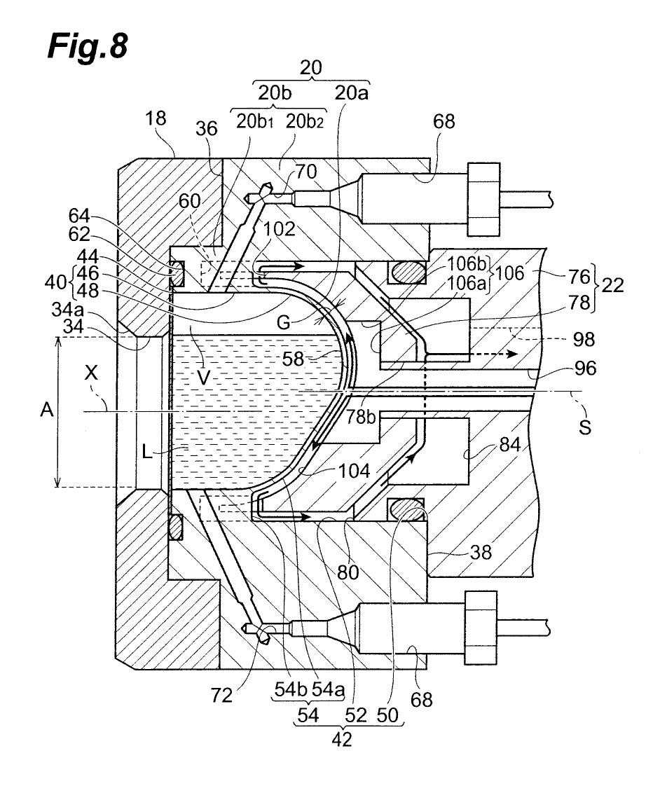

In the another example, the apex 58 is located above the middle of the thin-walled shell-like portion 20a in the vertical direction. Therefore, the volume of the holding unit 40 above an imaginary plane S (refer to FIG. 8), which passes through the middle of the thin-walled shell-like portion 20a (bottom surface 48 of the holding unit 40) in the vertical direction and is parallel to a horizontal plane, is made to be larger than the volume of the holding unit 40 below the imaginary plane S.

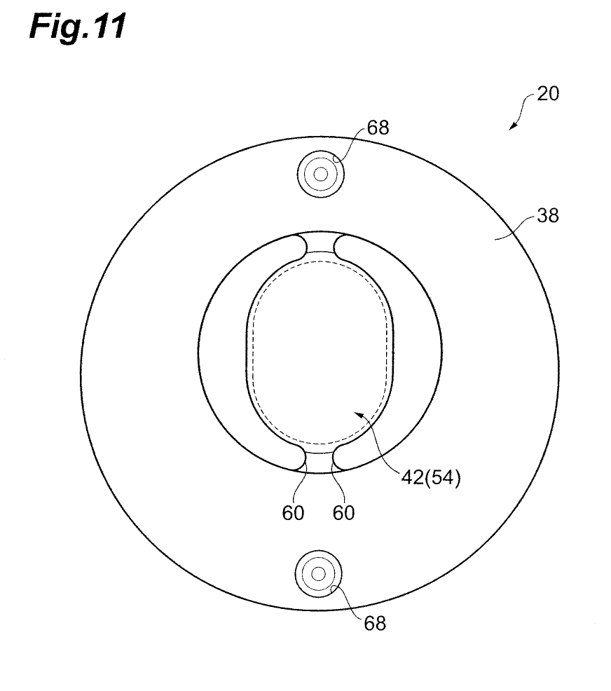

The annular supporting portion 20b includes a first portion 20b₁ which is directly connected with the thin-walled shell-like portion 20a, and a second portion 20b₂ which further surrounds the outside of the first portion 20b₁. The flat surface 54b which forms a portion of the first portion 20b₁ is provided with a plurality of (two in the another example) recesses 60 which is recessed in a direction which faces the radioactive rays radiated from the cyclotron 10 (refer to FIGS. 9 to 11). The recesses 60 are formed so that each surrounds a portion (about a semi-perimeter) of the inner wall surface 46 of the holding unit 40 (refer to FIGS. 8 and 10), and assume a substantially circular-arc shape as seen from the radiation axis X (refer to FIGS. 10 and 11).

A guide hole 96 for guiding cooling water extends at the main body 76 so as to pass through the main body from the nozzle hole 88 to the protruding portion 86 of the distal end face 80. In the another example, the distal end (portion on the side of the distal end face 80) of the guide hole 96 is formed into a straight tube shape (refer to FIGS. 7, 8 and 12).

The bowl-like member 78, as shown in FIGS. 7, 8, 12, and 13, has a corresponding concave surface 104 which assumes a shape corresponding to the convex surface 54a of the fitting recess 42. In the another example, a gap (rectilinear distance) G between the corresponding concave surface 104 of the bowl-like member 78, and the convex surface 54a (convex surface 54a of the thin-walled shell-like portion 20a) of the fitting recess 42 is set to be about 1 mm in a state where the third body portion 22 is fitted into the fitting recess 42 of the target 20 (refer to FIG. 8).

Additionally, the bowl-like member 78 is provided with a temporary storage recess 106 which is opened to the corresponding concave surface 104. The temporary storage recess 106 is constituted by a bottom surface 106a and a side surface 106b connected with the bottom surface 106a. The end of the side surface 106b opposite the bottom surface 106a is connected with the corresponding concave surface 104. The bowl-like member 78 is provided with a passage hole 78b which passes through the bowl-like member 78 from the bottom surface 106a to a back surface 78a of the bowl-like member 78. The distal end of the guide hole 96 of the main body 76 is fitted into the passage hole 78b. Therefore, the cooling water guided by the guide hole 96 is temporarily stored in the temporary storage recess 106.

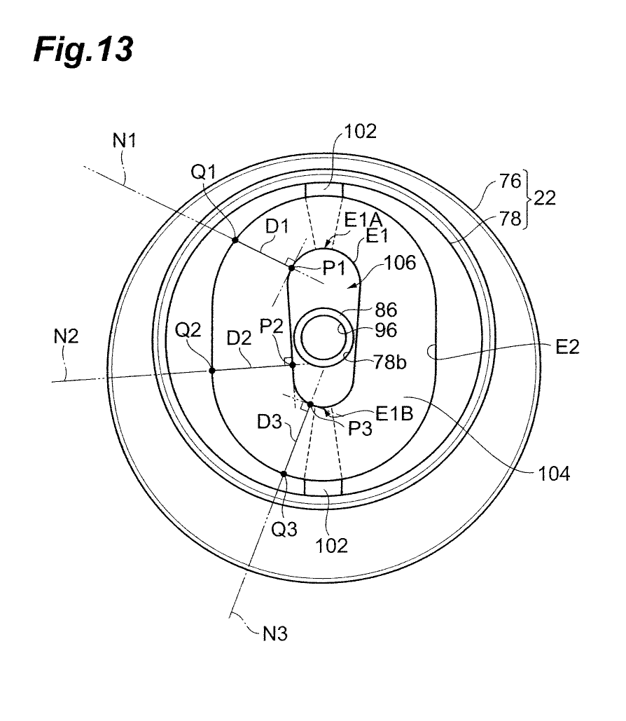

The temporary storage recess 106, as shown in FIG. 13, assumes a racetrack shape which is long in the vertical direction as seen from the radiation axis X. In the temporary storage recess 106, the radius of the upper circular-arc portion is larger than the radius of the lower circular-arc portion.

Here, the distance along the surface of the corresponding concave surface 104 which connects an arbitrary point P on the edge E on the side of the corresponding concave surface 104 of the temporary storage recess 106, and a point Q where a normal line N as seen from the radiation axis X at the point P of an edge E1 on the side of the corresponding concave surface 104 of the temporary storage recess 106 intersects an outer edge E2 of the corresponding concave surface 104 as seen from the radiation axis X is defined as the creeping distance D at the point P. At this time, in the bowl-like member 78, the creeping distances at substantially all the points on the edge E1 on the side of the corresponding concave surface 104 of the temporary storage recess 106 are almost the same.

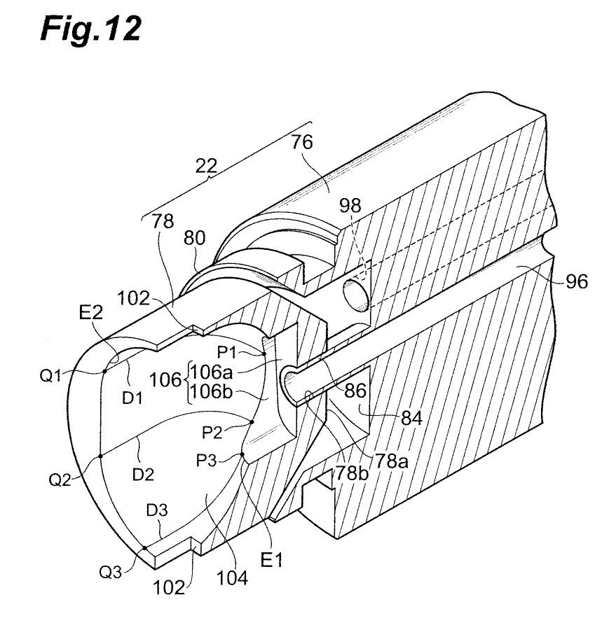

For example, as shown in FIGS. 12 and 13, a creeping distance D1 at a point P1, a creeping distance D2 at a point P2, and a creeping distance D3 at a point P3 are all 15.1 mm±0.1 mm. In addition, the expression “substantially all the points” means, when a normal line as seen from the radiation axis X at a point of the edge E1 on the side of the corresponding concave surface 104 of the temporary storage recess 106 passes through the portion of the outer edge E2 of the corresponding concave surface 104 as seen from the radiation axis X which is constituted by the cutout portion 102, excluding the point. In the another example, the points on edges E1A and E1B which are portions of the edge E1 on the side of the corresponding concave surface 104 of the temporary storage recess 106 are excluded. Additionally, the expression “almost the same” means, even when the creeping distance at each point on the edge E1 on the side of the opening of the temporary storage recess 106 has a range of about ±0.1 mm, permitting this.

(2.2) Operation and Effect

The radioisotope manufacturing apparatus 2 according to the another example as described above exhibits the same effect as the radioisotope manufacturing apparatus 1 according to the one example.

Additionally, in the another example the volume of the holding unit 40 above the imaginary plane S is larger than the volume of the holding unit 40 below the imaginary plane S. If the volume of the upper portion of the holding unit 40 is large in this way, the area of contact with cooling water increases in the upper portion (upper portion of the thin-walled shell-like portion 20a) of the holding unit 40. Thus, it is possible to very efficiently cool the upper portion of the holding unit 40 where the boiling target liquid tends to exist in gas form. Additionally, if the volume of the lower portion of the holding unit 40 is small in this way, the amount of expensive target liquid used can be suppressed. Thus, the cost can be reduced.

Additionally, in the another example, the apex 58 is located above the imaginary plane S. Therefore, the volume of the upper portion of the holding unit 40 is larger.

Additionally, in the another example, the holding unit 40 assumes an annular shape (racetrack shape) which is long in the vertical direction as seen from the radiation axis X. Therefore, since the volume of both portions of the holding unit 40 is small as compared with a case where the holding unit 40 assumes an annular shape which is long in the horizontal direction as seen from the radiation axis X, the amount of expensive target liquid used can be further suppressed.

Additionally, in the another example, the temporary storage recess 106 is provided in the bowl-like member 78 which temporarily stores the cooling water for cooling the target liquid L. If the cooling water guided by the guide hole 96 in this way is temporarily stored in the temporary storage recess 106, the cooling water guided by the guide hole 96 flows in between the convex surface 54a (convex surface 54a of the thin-walled shell-like portion 20a) of the fitting recess 42, and the corresponding concave surface 104 of the bowl-like member 78 after the flow velocity of the cooling water is slowed at the temporary storage recess 106. Thus, it is possible to reduce pressure loss caused when the cooling water guided by the guide hole 96 flows while spreading all over the convex surface 54a of the fitting recess 42. Therefore, there is hardly any drift of cooling water on the convex surface 54a of the fitting recess 42. As a result, it is easy to uniformly cool the target liquid L via the target 20 (thin-walled shell-like portion 20a).

Additionally, in the another example, the creeping distances at substantially all the points on the edge E1 on the side of the corresponding concave surface 104 of the temporary storage recess 106 are almost the same. Since this makes the lengths of flow passages for the cooling water in the corresponding concave surface 104 almost the same, pressure loss caused when the cooling water guided by the guide hole 96 flows while spreading all over the convex surface 54a of the fitting recess 42 can be further reduced.

Although the preferred embodiment of the invention has been described in detail hitherto, the invention is not limited to the above embodiment. For example, in the one example of this embodiment, the holding unit 40 has the bottom surface 48 which assumes a spherical shape. However, the holding unit 40 can be formed into convex surfaces of other shapes, not limited to the spherical shape, so long as the holding unit 40 is recessed in a direction away from the cyclotron 10 with respect to opening 44.

Additionally, in the one example of this embodiment, the target 20 is disposed so that the intersection position between the radiation axis X of the radioactive rays which are radiated from the cyclotron 10 and the bottom surface 48 of the holding unit 40 is located directly below the apex 58. However, the invention is not limited, and the intersection position between the radiation axis X of the radioactive rays which are radiated from the cyclotron 10 and the bottom surface 48 of the holding unit 40 can be located below the apex 58.

Additionally, in the one example of this embodiment, the target 20 is constituted by the thin-walled shell-like portion 20a which has the apex 58, and the annular supporting portion 20b which supports the thin-walled shell-like portion 20a. However, the target may not be shell-like, and can be thick-walled such that the convex surface 54a of the fitting recess 42 is formed in a planar shape.

Additionally, in the one example of this embodiment, helium gas is supplied to the holding unit 40 to raise the pressure within the holding unit 40. However, the invention is not limited to helium gas, and other inert gas can also be used.

Additionally, in the another example of this embodiment, the apex 58 is located above the imaginary plane S. However, if the volume of the holding unit 40 above the imaginary plane S is made larger than the volume of the holding unit 40 below the imaginary plane S, the position of an apex 58 is not limited to this.

Additionally, in the another example of this embodiment, the temporary storage recess 106 is provided in the bowl-like member 78. However, the temporary storage recess 106 does not need to be provided in the bowl-like member 78.

Additionally, in the another example of this embodiment, the creeping distances at substantially all the points on the edge E1 on the side of the corresponding concave surface 104 of the temporary storage recess 106 are almost the same. However, the corresponding concave surface 104 does not have to be formed into a shape which satisfies this condition.

What is claimed is:

1. A radioisotope manufacturing apparatus for manufacturing a radioisotope by a nuclear reaction between a target liquid and radioactive rays, the apparatus comprising:
a radiation source which radiates radioactive rays; and
target having a holding unit which holds the target liquid,
wherein the holding unit includes a concave surface which is recessed in a direction away from the radiation source so as to have an apex, and
wherein the target is disposed so that the intersection position between a radiation axis of the radioactive rays radiated from the radiation source, and the concave surface is located below the apex.

2. The radioisotope manufacturing apparatus according to claim 1,
wherein the target is disposed so that the intersection position between the radiation axis of the radioactive rays radiated from the radiation source, and the concave surface is located directly below the apex.

3. The radioisotope manufacturing apparatus according to claim 1,
wherein the concave surface is spherically formed.

4. The radioisotope manufacturing apparatus according to claim 1,
wherein the target has a thin-walled shell-like portion where one side forms a concave surface and the other side forms a convex surface, and an annular supporting portion which supports the thin-walled shell-like portion so as to surround the periphery of the thin-walled shell-like portion, and
the holding unit is constituted by a space surrounded by the thin-walled shell-like portion and the annular supporting portion.

5. The radioisotope manufacturing apparatus according to claim 4,
wherein the holding unit further includes a side surface which connects the concave surface, and the annular supporting portion is provided with a recess which is recessed in a direction toward the radioactive rays radiated from the radiation source so as to surround at least a portion of the side surface of the holding unit.

6. The radioisotope manufacture apparatus according to claim 1,
wherein the volume of the holding unit above an imaginary plane which passes through the middle of the concave surface in a vertical direction and is parallel to a horizontal plane is made larger than the volume of the holding unit below the imaginary plane.

7. The radioisotope manufacturing apparatus according to claim 6,
wherein the apex is located above the imaginary plane.

8. The radioisotope manufacturing apparatus according to claim 6,
wherein the holding unit assumes an annular shape which is long in the vertical direction as seen from the radiation axis of the radioactive rays radiated from the radiation source.

9. The radioisotope manufacturing apparatus according to claim 6,
wherein the target has a thin-walled shell-like portion where one side forms a concave surface and the other side forms a convex surface,
the manufacturing apparatus further comprises a bowl-like member having a corresponding concave surface which assumes a shape corresponding to the convex surface, and disposed so that the corresponding concave surface faces the convex surface, and
the bowl-like member is provided with a temporary storage recess which is opened to the concave surface, has a passage hole for introducing coolant for cooling the target liquid formed at the bottom thereof, and temporarily stores the coolant from the passage hole.

10. The radioisotope manufacturing apparatus according to claim 9,
wherein, when the distance along the surface of the corresponding concave surface which connects an arbitrary point P on an edge on the side of the corresponding concave surface of the temporary storage recess, and a point where a normal line as seen from the radiation axis of the radioactive rays radiated from the radiation source at the point P of an edge on the side of the corresponding concave surface of the temporary storage recess intersects an outer edge of the corresponding concave surface as seen from the radiation axis of the radioactive rays radiated from the radiation source, is defined as the creeping distance D at the point P, the creeping distances at substantially all the points on the edge on the side of the corresponding concave surface of the temporary storage recess are almost the same.

11. A radioisotope manufacturing method comprising:
preparing the radioisotope manufacturing apparatus according to claim 1;
circulating the coolant for cooling the target;
holding the target liquid within the holding unit so as to leave a predetermined air gap within the holding unit above the apex; and
radiating radioactive rays toward the target from the radiation source so that the intersection position between the radiation axis and the concave surface is located below the apex, and an irradiation area of the radioactive rays radiated from the radiation source falls within the target liquid.

12. The radioisotope manufacturing method according to claim 11, further comprising supplying inert gas into the holding unit to pressurize the inside of the holding unit after the step of holding the target liquid, and before the step of radiating radioactive rays toward the target from the radiation source.
